(19) United States
(12) Patent Application Publication
(10) Pub. No.: US 2025/0162050 A1
(43) Pub. Date: May 22, 2025

(54) METHOD FOR ROLLING HARD-FINE MACHINING OF A TOOTHING OF A WORKPIECE BY MEANS OF A GRINDING TOOL

(71) Applicant: KAPP NILES GMBH & CO. KG, Coburg (DE)

(72) Inventors: Philip GEILERT, Ahorn (DE); Achim STEGNER, Coburg (DE)

(21) Appl. No.: 18/839,810

(22) PCT Filed: Feb. 15, 2023
(86) PCT No.: PCT/EP2023/053738

§ 371 Date: Aug. 20, 2024

(30) Foreign Application Priority Data
Feb. 24, 2022 (DE) 10 2022 104 361.4

(51) Int. Cl. B23F 1/02

(52) U.S. Cl. CPC B23F 1/023

(57) ABSTRACT

A method for rolling hard-fine machining of a toothing of a workpiece by a grinding tool, in which the grinding tool is mounted on a tool spindle and rotates while the grinding tool engages with the toothing. The grinding tool is guided relative to the toothing during machining to grind the toothing over its width. The grinding tool rotates at a non-constant rotational speed during its engagement with the toothing at least over a portion of the width. The rotational speed of the grinding tool during its engagement with the toothing has a constant basic value on which an additionally time-varying rotational speed function is superimposed, or the rotational speed of the grinding tool during its engagement with the toothing increases or decreases continuously or non-continuously over the entire width of the toothing or increases or decreases continuously or non-continuously over portions of the width of the toothing.

The invention relates to a method for rolling hard-fine machining of a toothing of a workpiece by means of a grinding tool, in particular by means of a grinding worm, in which the grinding tool is mounted on a tool spindle and rotates about the tool axis while the grinding tool is in engagement with the toothing, wherein the grinding tool is guided relative to the toothing during the machining in order to grind the toothing over its width, and wherein the grinding tool rotates at a non-constant rotational speed during its engagement with the toothing at least over a portion of the width.

In the production of workpieces with gearing, high demands are sometimes placed on noise development during operation of the workpiece with the gearing. Efforts are made to apply topological corrections to the flank surface of the toothing or to change the surface structure of the toothing in an advantageous way. The aim is to positively influence the noise behaviour during operation of the hard-fine machined, in particular ground, toothing.

A method of the type mentioned above is mentioned in DE 10 2015 000 907 A1, which involves providing a grinding tool in the form of a grinding worm with a specific modification by modifying the position of a dresser relative to the tool during dressing. It is mentioned that the speed of the workpiece or tool and the feed rate of the tool or workpiece can change over time, although no specific details are provided.

DE 10 2015 209 917 A1 describes that during an actual grinding process, the process loads occurring on the tool and workpiece are determined by recording the drive power of the tool drive and analysing it, taking into account a correction function to eliminate external interference. The change in the rotational speed of the tool is also mentioned here in passing, without any specific details being given.

DE 10 2012 015 846 A1 envisages moving the tool eccentrically relative to the workpiece in order to modify the surface of the flank. The disadvantage of this method is that the equipment required is relatively high, as means must be provided for the eccentric movement of the tool.

For the same purpose, it is known from EP 1 600 236 A1 to move the feed of the tool relative to the workpiece at a varying feed rate. However, the effects that can be achieved with this are limited.

It is known from DE 10 2012 019 492 A1 that the feed movement of the tool relative to the workpiece is controlled as a function of the number of threads of the grinding worm and the number of teeth of the workpiece in order to improve the running noise of the gearing.

Solutions have also become known in which special dressing of the grinding tool is intended to improve the noise development of the toothing.

The invention is based on the object of further developing a generic process in such a way that it should be possible to effectively influence the surface structure of the tooth flanks during hard finishing in the simplest possible way and thus produce gears which are characterised by favourable noise behaviour during operation.

The solution to this problem by the invention provides that the rotational speed of the grinding tool during its engagement with the toothing has a constant basic value on which an additionally time-varying rotational speed function is superimposed, or that the rotational speed of the grinding tool during its engagement with the toothing increases or decreases continuously or non-continuously over the entire width of the toothing or increases or decreases continuously or non-continuously over portions of the width of the toothing.

This can be done by driving the grinding tool at a non-constant speed during its engagement with the toothing. Alternatively, it is also possible for the workpiece to be driven at a non-constant speed. This is because the rotations of the workpiece axis and the tool axis are coupled to each other via an “electronic gearbox”.

Preferably, the grinding tool rotates at the non-constant rotational speed over the entire width during its engagement with the toothing.

The time-varying rotational speed function can be periodic or non-periodic; in the latter case, a randomly generated superimposed value can be specified so that it has a stochastic character (e.g. superimposition of a “white noise”).

With regard to the continuous or non-continuous increase or decrease in rotational speed, for example, grinding can begin in one axial end area of the toothing with a starting value for the rotational speed, which then increases or decreases by 10% to 30%, for example, up to the other axial end area of the toothing.

With the proposed procedure, advantageous surface topographies can be generated with little effort (i.e. purely in terms of control technology).

The proposed procedure can be supplemented by changing the feed rate of the grinding tool relative to the toothing over the width of the toothing.

Another additional influencing option is that the grinding tool is displaced (shifted) in the direction of the tool axis over at least a portion of the width during its engagement with the toothing. It can be provided that the displacement movement (shift movement) takes place with a non-constant change in its speed. The shift movement can, for example, be oscillating in the direction of the tool axis. A stochastic character can also be provided for this movement.

Only a single tool can be arranged on the tool spindle; however, it is also possible for several different tools to be mounted on the tool spindle.

The type of grinding tools can, of course, be of any type. Dressable tools can be used, but also those with a steel base body that is coated with abrasive material.

With the above-mentioned relative guidance of the tool relative to the workpiece, superimposed movements can of course be taken into account in order to produce gear modifications, in particular crowning.

Where reference is made here to grinding the toothing, the use of a grinding worm is preferred in view of the intended rolling hard finishing. However, this nomenclature also refers to similar hard finishing processes for gears, which applies to both external and internal gears.

The proposed procedure makes it possible to influence the surface of the tooth flanks in a very simple way (i.e. purely in terms of control technology and without additional devices), so that the gears produced in this way have a more favourable noise behaviour. In particular, it is possible to avoid the defined waviness on the flank surface that can otherwise occur, which is unfavourable in terms of noise behaviour.

If the non-constant speed is selected appropriately, the gears produced using the proposed method do not exhibit any regularities across the gear width, so that the noise behaviour is more favourable during operation and the perceived noises are subjectively less noticeable, as there are no regularities.

The figures show embodiments of the invention.

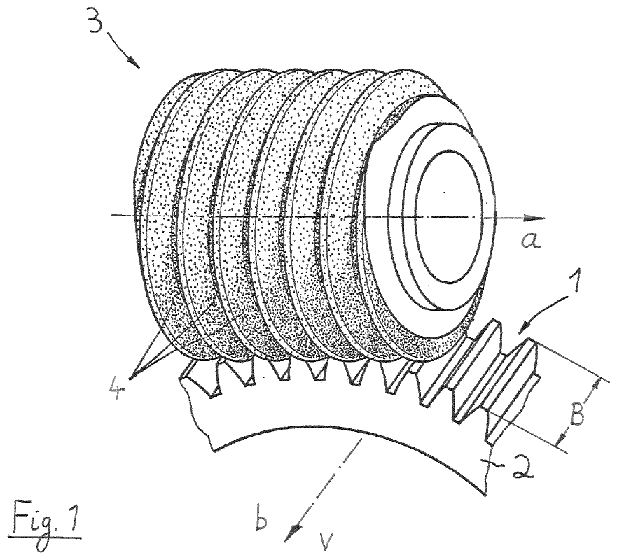

FIG. 1 shows a perspective view of a grinding worm used to grind the toothing of a workpiece,

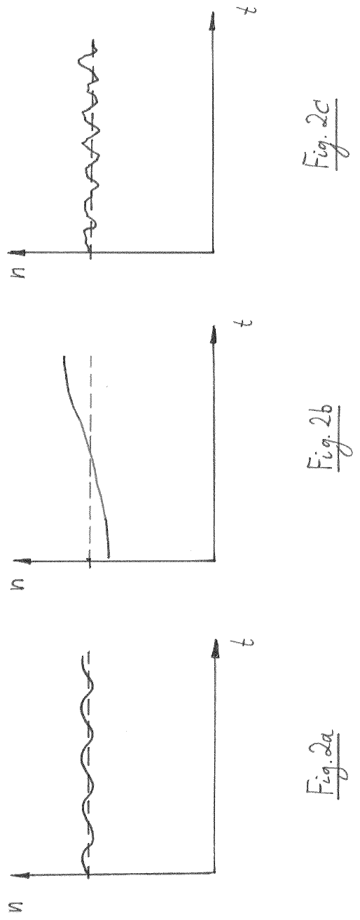

FIG. 2a,

FIG. 2b,

FIG. 2c,

FIG. 2d and

FIG. 2e schematically show the progression of the rotational speed of the grinding worm over time during the grinding process for five different embodiments of the invention.

FIG. 1 shows an example of a generating hard finishing operation on a workpiece 2 with a toothing 1 by generative grinding with a grinding worm 3, which machines the flanks of the toothing 1 with its abrasive surfaces 4 of the individual worm threads. The grinding worm 3 rotates around the tool axis a and is in the illustrated engagement with the toothing 1. Accordingly, the workpiece 2 rotates simultaneously (and coupled via an “electronic gearbox”) around the workpiece axis b.

Here, the grinding worm 3 is moved relative to the workpiece 2 in the direction of the workpiece axis b at a feed rate v in order to grind the toothing 1 over the entire width B of the toothing 1.

In this respect, the grinding process described corresponds to the state of the art.

It is important to note that the tool, i.e. the grinding worm 3, is now not driven at a constant rotational speed as usual, but at a non-constant rotational speed n.

This is outlined for five example cases in FIGS. 2a, 2b, 2c, 2d and 2e.

FIG. 2a shows that the rotational speed n of the grinding worm 3 has a constant base value over time (and thus also over the width of the toothing due to the given feed rate), which is superimposed with a sinusoidal curve.

According to FIG. 2b, it is also possible for the rotational speed n to begin with a starting value and increase over time. Accordingly, grinding can begin with a starting speed, which then increases steadily over the width of the toothing (as shown in FIG. 2b) or decreases steadily. A linear progression can be provided for the increase or decrease in rotational speed, but also a non-linear progression.

FIG. 2c illustrates that a stochastic or randomly selected function curve is superimposed on a constant base value for the rotational speed. This can be “white noise” in particular.

According to FIG. 2d, the grinding process begins with a starting rotational speed, which then increases to approximately the centre of the width of the workpiece, only to drop back to the original value by the end of the workpiece.

Finally, FIG. 2e shows a process in which grinding starts at a rotational speed that increases (disproportionately or exponentially) over time and thus over the width of the toothing.

In addition to the described change in tool speed n, the feed speed v can be selected to be non-constant. Any progression is also possible here.

Finally, another additive option is to “shift” the grinding worm 3 during the machining of the toothing 1, i.e. to move it slightly in the direction of the tool axis b. Any course can also be specified for this movement.

As described, in addition to a constant change (also: in addition to a constant acceleration) of the input variables (rotational speed, feed, shift movement), any modulation of the aforementioned input variables is also conceivable. For example, this can be set via the order and amplitude (indirect phase position (decimal point order)). An acceleration can also be superimposed on this. The order and amplitude can be varied via the stroke (i.e. via the width of the toothing). The modulation can be free of a clear system (e.g. “white noise”). Similarly, the change in speed can be dynamic. A simultaneous or staggered combination of dynamic influencing of the input variables (rotational speed, feed, shift movement) is also possible.

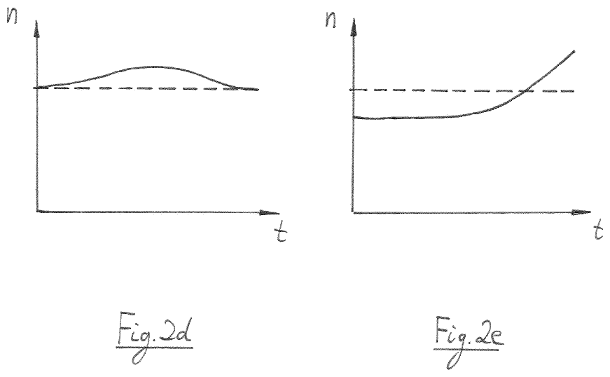

Another (albeit equivalent and equally effective) realisation of the proposed solution for changing the rotational speed of the tool is to influence the “electronic gearbox”, which realises synchronous, coordinated rotation of the tool 3 about the tool axis a and the workpiece 2 about the workpiece axis b. In the corresponding control algorithm, which establishes the synchronisation between axes a and b, a superimposition function of the type outlined in FIGS. 2a, 2b and 20 can be specified, for example, so that the synchronisation between the axes is not as high as possible—as is usually the aim—but rather a targeted deviation from it. This can also achieve the stated objective.

### LIST OF REFERENCES

1 Toothing
2 Workpiece
3 Grinding tool (grinding worm)
4 Abrasive area
a Tool axis (axis of the grinding worm)
b Workpiece axis
B Width of the toothing
n Rotational speed of the grinding tool
v Feed rate of the grinding worm relatively to the toothing

1-7. (canceled)

8. A method for rolling hard-fine machining of a toothing of a workpiece by means of a grinding tool, in particular by means of a grinding worm, in which the grinding tool is mounted on a tool spindle and rotates about the tool axis while the grinding tool is in engagement with the toothing, wherein the grinding tool is guided relative to the toothing during the machining in order to grind the toothing over its width, and wherein the grinding tool rotates at a non-constant rotational speed during its engagement with the toothing at least over a portion of the width, wherein the rotational speed of the grinding tool during its engagement with the toothing has a constant basic value on which an additionally time-varying rotational speed function is superimposed, wherein the time-varying rotational speed function is periodic or wherein the time-varying rotational speed function has a stochastic character.

9. The method according to claim 8, wherein the feed rate of the grinding tool changes relative to the toothing over the width of the toothing.

10. The method according to claim 8, wherein the grinding tool is shifted in the direction of the tool axis over at least a portion of the width during its engagement with the toothing.
